(19) United States
(12) Patent Application Publication
(10) Pub. No.: US 2024/0057495 A1
(43) Pub. Date: Feb. 22, 2024

(54) HITCHING METHOD AND DEVICE FOR AGRICULTURAL VEHICLE

(71) Applicant: Hubert DEFRANCQ, GUIGNICOURT (FR)

(72) Inventor: Hubert DEFRANCQ, GUIGNICOURT (FR)

(21) Appl. No.: 18/259,870

(22) PCT Filed: Dec. 14, 2021
(86) PCT No.: PCT/EP2021/085751

§ 371 Date: Jun. 29, 2023

(30) Foreign Application Priority Data
Dec. 29, 2020 (FR) 2014219

(51) Int. Cl. A01B 59/06; B60D 1/14

(52) U.S. Cl. CPC A01B 59/066; B60D 1/141

(57) ABSTRACT

A method and a device for hitching a tool to an agricultural vehicle by a system for coupling the agricultural vehicle to a first frame, the coupling system including two hooks which extend substantially in the progression direction of the hitch, each of the hooks being provided with a first end that is proximal and a second end that is distal relative to the first free frame and being intended to be connected to the tool, the second free ends defining, once connected to the tool, a direction, the coupling system further having elements which are positioned between the first proximal ends of the hooks and the first frame in order to pivot, about the vertical axis, the direction, defined by the second free distal ends.

### FIELD

The present invention relates to the field of technical vehicles and is particularly concerned with a device for hitching and raising an agricultural tool, able to be mounted on an agricultural vehicle, and more particularly at the rear of said vehicle.

The present invention relates more particularly to the transverse adjustment of the position of the agricultural tools drawn by a vehicle able to laterally vary the position of the tool in response to a signal so as to reliably maintain a preselected path or follow the rows of crops on the ground so as not to damage said crops during plant-care operations. The signal may be a geolocalization (GPS) signal, a video image, an ultrasound sensor or a mechanical sensor.

### BACKGROUND

Agriculture has developed toward precision agriculture thanks to the advent of satellite navigation systems such as GPS, or else nondestructive means for detecting the crops on the ground. By using GPS equipment, a farmer is thus able to locate a precise position in a field, allowing the areas being exploited to be mapped with precision according to a large number of parameters such as the crop yield, the topography, the organic-matter content, the moisture level, the nitrogen content, the pH, etc. The manufacturers of precision equipment have begun to supply autoguidance systems which use the GPS signals to direct an agricultural vehicle, and notably a tractor, along a predetermined path. Although such equipment works well at reliably and precisely guiding the agricultural vehicle, the variations in soil and topography limit the reliable and precise positioning of the tools that are being drawn.

A number of solutions for controlling the geolocalization of an agricultural tool hitched to a tractor have been envisaged.

Such solutions are connected to the drawbar of the tractor or to the two lower linkage points of the rear hitch. These solutions consist of a connection fixed to the tractor by means of a drawbar or else two or three fixing points, and an interface for moving the tool transversely, according to the signal for geolocalization or for the detection of crops on the ground, so that the tool travels in the same direction as the tractor or avoids damaging the crops on the ground.

In a first approach, the tool moving interface causes this tool to turn about a vertical axis. In order to work, the rear hitch of the tractor needs to have a free balance beam capability. The tool needs to be equipped with a device that is engaged in the ground (essentially at least one disk), which generates a lateral force to move the tool in the desired direction. This correction system is, however, sensitive to the typology of the soil and the side slope of the terrain.

In a second approach, the tool movement interface causes the tool to move translationally sideways. In order to work, the rear hitch of the tractor needs to be locked, without any balance beam capability. However, this type of solution is not compatible with tools that are deeply engaged in the soil.

One solution has therefore been to equip the interface with anchor points, against which a movement reaction is applied in order to move the working unit to the side, while the rear hitch of the tractor maintains a free balance beam capability. These arrangements are, however, applicable only to tools that are easy to draw and only weakly anchored into the soil.

Another solution described in document WO2016041547A1 proposes modifying the hitch by varying the length of the arms using a ram so as to allow the interface to rotate in addition to the ability of the tool to effect a translational movement. However, this solution entails modifying the standard hitches and leads to complex control of the accompanying movements of the hitch and of the interface. In addition, the objective is to obtain a tool orientation that is parallel to the direction of travel of the tractor as described in the diagrams of FIGS. 3 to 11, and this is insufficient because it implies a need to compensate for the sideways movement of the rear of the tractor opposite to the desired positioning of the tool (cf. FIGS. 2, 12, 13).

Propositions aimed at managing the sideways movement and the orientation always result in a system operated with complex control that is unable to overcome the parasitic dynamic stresses applied to the tool.

In a third approach, document U.S. Pat. No. 6,089,328 A1 describes a rear hitch equipped with rams commanding a sideways movement of the lower arms. However, this configuration as defined is unable to perform the desired function. Specifically, the separation of the arms is narrower in the part opposite the hitch of the tool compared with the separation on the side of the hitching to the tool, the width of which is defined by standard ISO 730/1.

During the offset sideways movement, the tool is oriented in a direction opposite to its travel and describes an arc of a circle, thereby impairing its ability to work in a straight line and disrupting the path of the tractor.

In a fourth approach, document WO2018172458 proposes moving the agricultural tool sideways relative to the agricultural vehicle in order to compensate for the offset of the point of convergence so that the tool remains positioned relative to its desired path, this being despite asymmetries of the ground and of the relief. FIG. 3 of document WO2018172458 more particularly describes two rigid pins 63, 64 on which the lifting arms 7a, 7b which, by definition, allow the tool to be raised in order to hold it off the ground, can be fixed. The controlled lateral movements of the frame 6 and the frame 8 moving one relative to the other mean that the connection between the frame 6 and the lifting arms 7a, 7b allows only pivoting about the transverse axis. Pivoting about the vertical axis is provided only by the pivoting through the angle alpha of the catching hooks 41 and 42 formed at the rear of the second frame.

This solution allows the agricultural vehicle to be moved sideways so that the tool follows the desired path despite its offsets relative to the vehicle. This solution offers the benefit of being universal, being able to be installed on any tractor rear hitch.

However, that results in an appreciable weight and an increase in the offset of the tool relative to the tractor.

Other documents offer fairly cumbersome and complex solutions aimed at creating degrees of freedom in the rear hitches.

Document U.S. Pat. No. 8,813,864 B2 describes a grader 100 comprising an assembly referred to as inner frame assembly 110 (FIG. 3b) and an assembly referred to as outer frame assembly 140 (FIG. 3c).

As shown most clearly in FIG. 3a, the inner frame 110 can be coupled reversibly to the tractor by a three-point hitch 21 which is coupled to the chassis of the tractor. The three-point hitch 21 comprises a central arm 23, two upper arms 25, two connecting arms 27 and two lower arms 29 (cf. FIGS. 1 and 2). The lower arms 29 are coupled in a mobile manner to the tractor and can be raised and lowered by means of a hydraulic ram or by means of another known mechanism. The central arm 23 is coupled in a mobile manner to the tractor above and/or between the lower arms 29.

However, because the context here is that of a three-point hitch 21, none of the arms (25, 27, 29) has at its end that is proximal relative to the first frame (112), a first pivot connection with the first frame (112), allowing said arm to pivot relative to the first frame about the vertical axis (z) or a second pivot connection with the agricultural vehicle at its end that is distal relative to the first frame (112), allowing said arm to pivot relative to the agricultural vehicle about the vertical axis.

The objective of document U.S. Pat. No. 8,813,864 B2 is in fact to propose a system having external guidance that prevents the offsetting brought about by the grader blades.

Document WO2021/004888 A1 relates to a hitching device for a tool, able to be mounted on an agricultural vehicle (1), comprising a frame (8) that is transverse to the direction of operation of the hitch, a system (41, 42) for hitching a tool to the frame, the hitching system being designed to pivot freely relative to the frame (8) about a vertical axis (z), an attachment device for attaching the frame (8) to the agricultural vehicle, the attachment device comprising at least two arms (7a, 7b) which are intended to connect the frame (8) to the agricultural vehicle, and each of which bears two pivot connections (L1a, L1b, L2a, L2b) which together define a deformable parallelogram (P).

However, the hitching device has no system for coupling the agricultural tool to the frame 8 with means interposed between said proximal first ends of the catching hooks and the frame so as to cause the direction defined by the distal second ends to pivot about the vertical axis.

Document WO 2021/146615 describes an autonomous agricultural system 10 comprising at least a power unit 12 configured to propel, transport and/or supply operational power to at least one tool 14, which may be fixed removably to the power unit 12 via a coupling assembly 16.

However, the hitching device comprises no system for coupling the agricultural tool to the frame 16 with means interposed between said proximal first ends of the catching hooks and the frame in order to cause the direction defined by the distal second ends to pivot about the vertical axis while at the same time allowing the attachments to pivot freely about the vertical axis.

Document U.S. Pat. No. 5,094,300 describes, in FIG. 10, a slight adjustment to steering which has begun to move the tractor 300 to the right in order to follow the bend 310 in the marker furrow. The guidance mechanism 12 has made an angular adjustment so as to compensate for this sideways movement of the tractor relative to the segment of furrow 304 at the detection mechanism 60 before the catching hook 310. The tool 302 is still aligned with the marker furrow 304 and in straight alignment with the towbar accessory 10.

In order to prevent the tool from disrupting the path of the tractor, force is brought to bear on stabilizing colters the lateral reaction of which is enough to compensate for the line of draft of the tractor and which is oriented in an opposite direction to the direction in which the tool is to go.

However, the hitching device comprises no system for coupling the agricultural tool 302 to the frame 10 with means interposed between said proximal first ends of the catching hooks situated at 310 and the frame 10 in order to cause the direction defined by the distal second ends situated at 302 to pivot about the vertical axis (the pivot point is effectively free, with no means for actuating it).

Document U.S. Pat. No. 2,640,708 describes a hitch 1 designed to be fixed to a tractor 3 and comprising a vertical pivot 7 and a rotary plate 8 designed to be adjusted and kept in the adjusted position, or allowed to turn freely, by means of a control rod 10.

However, the hitching device comprises no system for coupling the agricultural tool 27 to the frame 26 with means interposed between said proximal first ends of the catching hooks 28 and the frame 26 in order to cause the direction defined by the distal second ends to pivot about the vertical axis. There is no possibility of pivoting between the agricultural tool 27 and the frame 26.

This is why it has proven necessary to develop a solution that is lightened in terms of weight, that can be suited to the standards of agricultural vehicles without the need to make modifications, and that can be compatible with the small amount of space available at the rear hitch and with tools that are firmly anchored into the ground.

### SUMMARY

Thus, the subject matter of the present invention seeks to cause the hitch to move sideways, something that the agricultural vehicle cannot do, while at the same time maintaining the flexibility of a connection that allows self-alignment of the hitch, while at the same time reducing the weight and offset of the device.

The subject of the invention is to provide the guidance function while at the same time maintaining the geometric benefits as described in application WO2018/172458 while at the same time maintaining the original hitching arms of the tractor.

More specifically, one subject matter of the invention is a hitching device for hitching a tool, able to be mounted on an agricultural vehicle, the device comprising:
a first frame extending in a transverse direction substantially perpendicular to the direction of travel of the hitch, said directions defining a horizontal plane,
a fixing device for fixing the first frame to the agricultural vehicle, the fixing device comprising at least two hitching arms extending in a direction close to the direction of travel of the hitch, as well as advantageously a retaining arm, these arms being intended to connect the first frame to the agricultural vehicle, said fixing device being further provided with actuating means,
each of the arms comprising, at its end that is proximal relative to the first frame, a first pivot connection with the first frame, allowing said arm to pivot relative to the first frame about the vertical axis, as well as a second pivot connection with the agricultural vehicle at its end that is distal relative to the first frame, allowing said arm to pivot relative to the agricultural vehicle about the vertical axis, the four pivot connections together thus defining a quadrilateral that can be deformed under the action of the actuating means,
a system for coupling the agricultural tool to the first frame, said coupling system comprising two catching hooks extending substantially in the direction of travel of the hitch, each of said catching hooks being provided with a first end that is proximal relative to the first frame, designed to pivot freely relative to said frame about the vertical axis, and with a second end that is distal relative to the first frame, free and intended to be connected to the tool, said free second ends, once connected to the tool, defining a direction (y′), also defined by the proximal first ends, said coupling system further comprising means interposed between said proximal first ends of the catching hooks and the first frame so as to cause the direction (y′) defined by the distal second ends to pivot about the vertical axis.

The direction (y′) is defined by the second ends that are distal relative to the first frame, when said second ends are connected to the tool.

Likewise, the direction (y′) is also defined by the first ends that are proximal relative to the first frame, the catching hooks being of the same length.

Optional additional or substitute features of the invention are listed hereinafter.

According to a first embodiment, the pivoting means interposed between said proximal first ends of the catching hooks and the first frame are means, preferably of the hydraulic ram type, for actuating the translational movement of the catching hooks independently of one another, in the direction of travel of the hitch.

According to this embodiment and advantageously, the pivoting means interposed between said proximal first ends of the catching hooks and the first frame consist mainly of a first and a second double connecting rod each respectively articulating one of the first ends of the catching hooks relative to the frame, for actuating the translational movement of the catching hooks independently of one another, in the direction of travel of the hitch.

Still according to this embodiment and advantageously, the actuating means of the fixing device are hydraulic rams and the first and second double connecting rods are actuated in translation respectively by a first and a second hydraulic ram.

According to a second embodiment, the pivoting means interposed between said proximal first ends of the catching hooks and the first frame consist mainly of a second frame mounted with the ability to pivot relative to the first frame on a vertical pin, the first ends of the catching hooks then being fixed to the second frame.

According to this embodiment and advantageously, the actuating means of the fixing device are hydraulic rams and the means for actuating the pivoting of the second frame are a pin made to rotate in opposite directions by a first and a second hydraulic ram.

Advantageously and according to the first embodiment, the first ends of the catching hooks are connected to the first frame with a pivot connection pivoting about the transverse direction substantially perpendicular to the direction of travel of the hitch, and retained vertically by means of link rods mounted on the first frame.

Advantageously and according to the second embodiment, the first ends of the catching hooks are connected to the second frame with a pivot connection pivoting about the transverse direction substantially perpendicular to the direction of travel of the hitch, and retained vertically by means of link rods mounted on the second frame.

As a preference, the hitching device comprises lifting means comprising link rods connected at one of their ends respectively to the hitching arms, which combine with the retaining arms connecting the upper part of the first frame to the agricultural vehicle.

Another subject matter of the invention is a method for operating a hitching device for a tool mounted on an agricultural vehicle traveling in a direction, the device being in accordance with the first or second embodiment set out above, characterized in that when one of the actuating means of the hitching arms commands the offsetting of the hitching device, thus causing the first frame to pivot relative to the transverse direction through an angle a, the means interposed between the proximal first ends of the catching hooks and the first frame are actuated to allow the direction (y′) defined by the connection of the distal second ends to the catching hook to pivot through an angle-a about the vertical axis so that said direction (y′) coincides with the transverse direction.

As explained previously, the direction (y′) is defined by the second ends that are distal relative to the first frame, when said second ends are connected to the tool.

Likewise, the direction (y′) is also defined by the first ends that are proximal relative to the first frame, the catching hooks being of the same length.

Optional additional or substitute features of the invention are listed hereinafter.

According to certain features that use hydraulic actuation, the actuating means are rams each respectively used to command the offsetting of the hitching arms and to manage the rams that control the pivoting means, each actuating means being in fluidic communication with the control ram of the pivoting means associated with it. Thus, when the actuating means actuate the offsetting of the hitch, they, through fluidic communication, actuate the control rams of the pivoting means, so as to counterbalance the pivoting of the direction (y′) defined by the free second ends of the catching hooks.

According to other features using hydraulic actuation, one of the actuating means of the hitching arms is a ram used to command the offsetting of the hitching arms, while the other actuating means is a ram used to manage the rams which control the pivoting means, the management ram being in fluidic communication with all the rams that control the pivoting means. Thus, when the operating ram causes the offsetting of the hitch, the management ram through fluidic communication actuates the control rams of the pivoting means so as to counterbalance the pivoting of the direction (y′) defined by the free second ends of the catching hooks.

Advantageously, the rams that control the pivoting means are in fluidic communication in a loop that includes a damper so as to slow the pivoting of the direction (y′) defined by the free second ends of the catching hooks.

### BRIEF DESCRIPTION OF THE FIGURES

Further advantages and specifics of the invention will become apparent from reading the detailed description of entirely nonlimiting implementations and embodiments and from studying the following attached drawings:

FIG. 1 is a view from above of a hitching device coupled to a tool and to an agricultural vehicle according to the invention.

FIG. 2 is a three-quarters front view of just said device according to a first embodiment.

FIG. 3 is a view from above of just said device according to the first embodiment.

FIG. 4 is a three-quarters rear view of just said device according to the first embodiment, with a detail regarding the hydraulic actuation.

FIG. 5 is a three-quarters rear view of just said device according to the first embodiment with another detail regarding the hydraulic actuation.

FIG. 6 is a side view of just said device according to the first embodiment.

FIG. 7 is a view from above of just said device according to a second embodiment.

FIG. 8 is a three-quarters rear view of just said device according to the second embodiment with a detail regarding the hydraulic actuation.

FIG. 9 is a three-quarters rear view of just said device according to the second embodiment with another detail regarding the hydraulic actuation.

FIG. 10 is a three-quarters front view of just said device according to the second embodiment.

FIG. 11 is a three-quarters rear view of just said device according to the second embodiment with another detail regarding the hydraulic actuation.

FIG. 12 is a three-quarters rear view of just said device according to the first embodiment with another detail regarding the hydraulic actuation.

For the sake of clarity and conciseness, the references in the figures correspond to the same elements.

### DETAILED DESCRIPTION

Since the embodiments described hereinafter are in no way limiting, variants of the invention containing just a selection of the features described, isolated from the other features described may notably be considered (even if this selection is isolated from within a sentence containing these other features) if this selection of features is sufficient to confer a technical advantage or to differentiate the invention from the prior art.

This selection contains at least one feature, preferably a functional feature without structural details, of with just some of the structural details if this portion alone is sufficient to confer a technical advantage or to differentiate the invention from the prior art.

In addition, the various features, forms, variants and embodiments of the invention may be combined with one another in various combinations provided that they are not mutually incompatible or mutually exclusive.

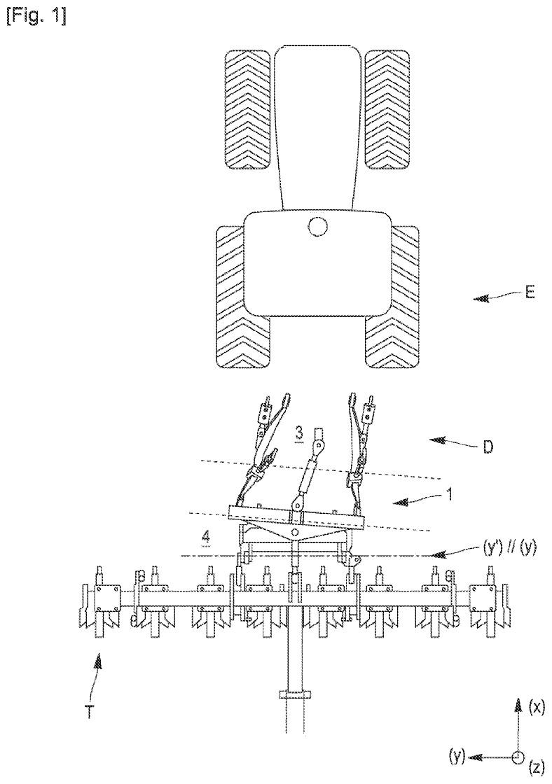

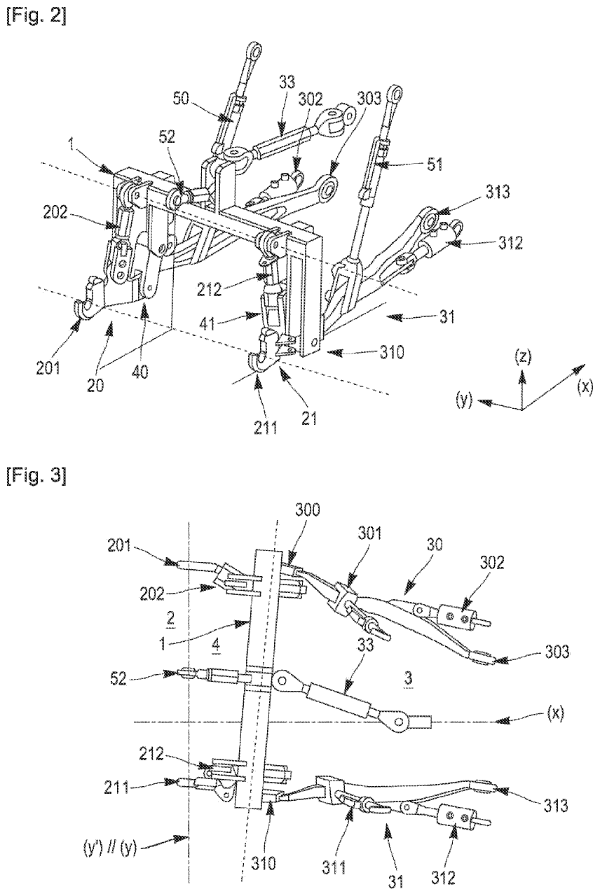

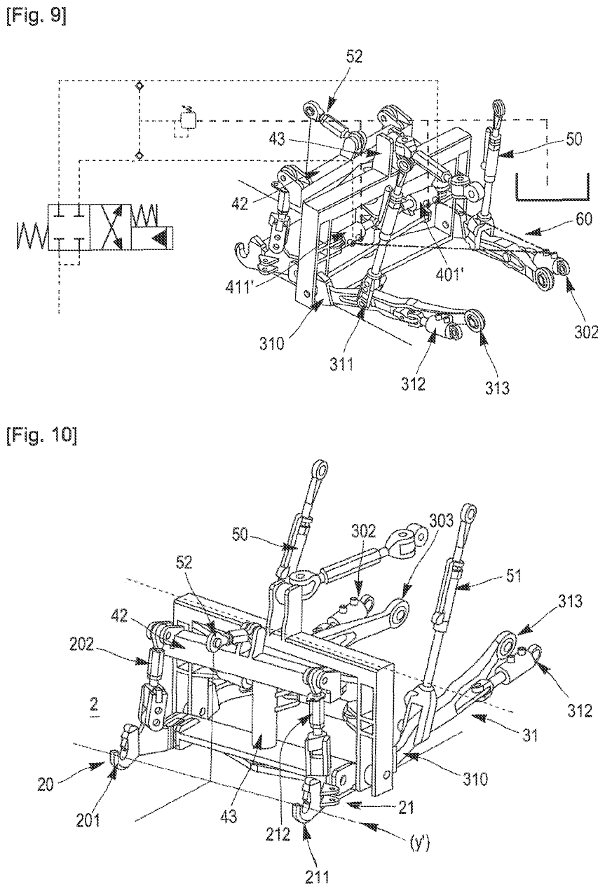

FIG. 1 schematically describes a device D for hitching a tool T to an agricultural vehicle E, the other FIGS. 2 to 12 depicting details of this device. The direction (x) which corresponds to the direction of travel of the hitch, the direction (y) which corresponds to the transverse direction, namely the direction perpendicular to the direction (x), in the horizontal plane, and the vertical direction (z) have been indicated.

In FIGS. 2 to 12, the hitching device D comprises a first frame 1 which, depending on the offsets, extends in a substantially transverse direction, which is to say perpendicular to the direction of travel x of the hitch.

The hitching device D also comprises a fixing device 3 for fixing the first frame 1 to the agricultural vehicle E and which consists of at least two hitching arms 30, 31 which themselves extend in a direction close to the direction of travel x of the hitch.

Advantageously, the fixing device for fixing the frame to the agricultural vehicle may comprise in the upper part a connecting element, referenced 33, connecting the upper part of the frame and the agricultural vehicle. This connecting element may consist in another arm, referred to as retaining arm, fixed at one of its ends at an articulation point to the agricultural vehicle and at the other of its ends to an articulation point on the frame. Of course, these articulation points are of the ball-jointed or double-jointed type, so as to allow said frame to be raised.

These hitching arms 30, 31 are used to connect the first frame 1 to an agricultural vehicle to which they are fixed at one of their ends, 303 and 313 respectively, and are each provided with actuating means 302, 312 respectively, to cause them to pivot in the horizontal plane in order to bring about the offsetting of the frame 1.

Each of the hitching arms 30, 31 comprises at its end that is proximal relative to the first frame 1 a first pivot connection 300, 310 with the first frame 1, allowing said arm to pivot relative to the first frame 1 about the vertical axis z, and a second pivot connection 303, 313 with the agricultural vehicle, allowing said portion of said arm to pivot relative to the agricultural vehicle E about the vertical axis (z).

Given the divergence of the hitching arms from the agricultural vehicle, the four pivot connections 300, 310, 303, 313 therefore together define a quadrilateral that is deformable under the action of the actuating means 302, 312.

The hitching device D further comprises a system 2 for coupling the agricultural tool to the first frame 1, which comprises two catching hooks 20, 21 which extend substantially longitudinally bearing in mind the fact that they converge in order to conform to the functional recommendations in accordance with standard ISO 730 and according to the offsets in the direction of travel (x) of the hitch.

These catching hooks 20, 21 define a first end, referred to as proximal relative to the first frame 1, and a second end 201, 211, that is distal relative to the first frame 1.

The first ends that are proximal relative to the first frame are connected to said frame while the distal second ends 201, 211 are left free to be connected to the tool T.

The proximal first ends are mounted relative to the first frame with a connection free to pivot about the vertical axis (z). Thus, when the frame effects a translational movement in the transverse direction (y), the pivoting allowed by the free movement of the catching hooks allows the translational movement to take place without introducing any stress that might disrupt the path of the agricultural vehicle and without applying excessive lateral stress to the agricultural tool.

The latter continuously self-balances during the offsetting movement of the frame and repositions itself on the desired path without mechanical stresses disrupting the forward travel of the agricultural vehicle. The permitted convergence between the directions supported by the catching hooks causes the agricultural tool to rotate slightly thus facilitating its offsetting movement and stabilizing it on its natural path.

Said second ends 201, 211, once connected to the tool, define a direction (y′) which, according to the invention, needs to be kept coincident with the transverse direction (y). As explained previously, the direction (y′) is also defined by the first ends that are proximal relative to the first frame.

Specifically, the catching hooks 20 and 21 are of similar lengths, so that when the distal second ends 201, 211 are fixed to the tool (T) the proximal first ends and distal second ends together form a trapezoid.

This trapezoid is also deformable because the first ends that are proximal relative to the first frame 1 are designed to pivot freely relative to said frame about the vertical axis.

For this purpose, the coupling system 2 comprises means 4 interposed between said proximal first ends of the catching hooks 20, 21 and the first frame 1 so as to cause the direction (y′) defined by the distal second ends 201, 211 to pivot about the vertical axis z.

According to a first embodiment described in FIGS. 2 to 6, the pivoting means 4 interposed between said proximal first ends of the catching hooks 20, 21 and the first frame 1 consist mainly of a first and a second double connecting rod 40, 41 each respectively articulating one of the first ends of the catching hooks 20, 21 relative to the frame so as to actuate the translational movement of the catching hooks independently of one another, in the direction of travel x of the hitch.

According to this first embodiment, it is clear that the catching hooks 20, 21 are connected to the first frame via the double connecting rods 40, 41.

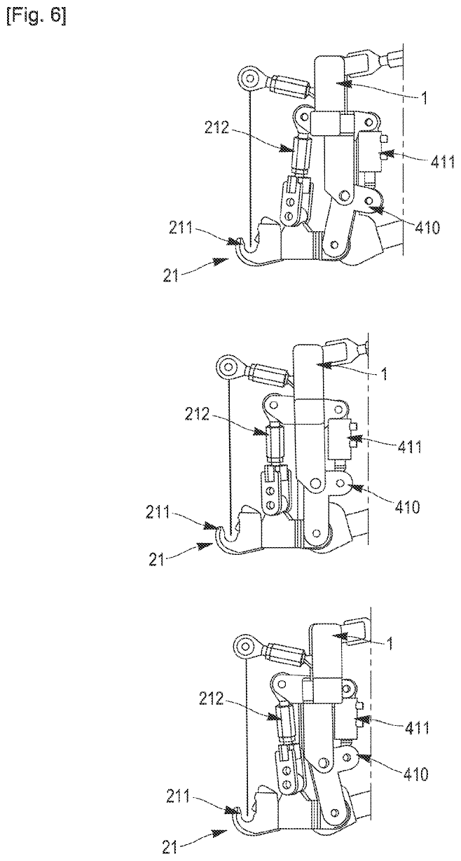

As depicted in FIG. 6, the use of double connecting rods makes it possible, through their layout, to free up the central part of the frame so that the transmission used for driving driven tools can pass through and allows the height of the ends 201, 211 to be preserved as they move forward/backward.

According to this first embodiment, the actuating means 302, 312 of the hitching arms 30, 31 of the fixing device 3 are hydraulic rams.

The actuating means 302, 312 may be of the single-acting or indeed double-acting ram type, and they are fixed at one end to the agricultural vehicle and at the other end to the hitching arm, before the pivot connection of the arms to the first frame, or else directly to the first frame.

It would also be conceivable to use just one actuating means of the double-acting ram type, assigned in instances where there is just one arm.

It would also be conceivable to use two double-acting rams, for each of the arms.

Likewise, the first and second double connecting rods 40, 41 are both actuated by a first 401 and a second 411 hydraulic ram respectively.

Advantageously, the first ends of the catching hooks may be connected to the first frame 1 with a pivot connection about the direction (y) substantially perpendicular to the direction of travel (x) of the hitch, and by means of link rods 202, 212.

The link rods may be configured in a fixed-length or a floating-length mode.

This setup facilitates the progression of the agricultural tool such that it is able to absorb the effects of the typology of the soil and the side slope of the terrain.

When the link-rod function is performed by means of hydraulic rams, these may then be able, by remote control, to perform the fixed-length, floating-length modes, the modes involving oscillation and increase of the lifting travel of the tool, in addition to or as a replacement for the lifting travel of the device for connection to the frame of the agricultural vehicle.

According to a second embodiment, the pivoting means 4 interposed between said proximal first ends of the catching hooks 20, 21 and the first frame 1 consist mainly of a second frame 42 mounted with the ability to pivot relative to the first frame 1 on a vertical pin 43, the first ends of the catching hooks 20, 21 then being fixed to the second frame.

According to this second embodiment, it is clear that the catching hooks 20, 21 are mounted directly on the second frame 42.

According to this second embodiment, the actuating means 302, 312 of the fixing device 3 are hydraulic rams.

Likewise, the means for actuating the pivoting of the second frame 42 are a pin 43 made to rotate in opposite directions by a first 401′ and a second 411′ hydraulic ram.

Advantageously, the first ends of the catching hooks may be connected to the second frame 42 with a pivot connection about the direction (y) substantially perpendicular to the direction of travel (x) of the hitch, and by means of link rods 202, 212 the benefit of which was detailed hereinabove.

According to one advantageous particular feature, the hitching device may comprise lifting means comprising for example link rods 50, 51 connected at one of their ends to the respective connecting points 301, 311 of the hitching arms 30, 31. The connecting points 301, 311 allow the connection of the link rods 50, 51 that control the vertical movement of the arms 30, 31.

The link rods 50, 51 of the agricultural vehicle connect the arms 30, 31 at their lower end, which preferably consists of a clevis, and are connected at their upper end to the lifting means of the agricultural vehicle.

A retaining element 52 between the upper part of the first frame and the agricultural vehicle may also be provided.

This additional retaining element 52, which is situated at the upper part of the first or of the second frame depending on whether the embodiment concerned is the first or the second embodiment, may be added for the purposes of retaining the tool when raised, so that said tool can be raised integrally. The presence of this additional element means that the agricultural tool can be used in semi-mounted mode, or even in mounted mode provided that there is a connecting element connecting the upper part of the frame and the agricultural vehicle.

In order to accompany the balance beam movements of the agricultural tool (these movements lie in the horizontal plane), the element 52 situated at the upper part of the frame may also pivot about the vertical axis (z). To achieve this, the element 52 may be fixed to the upper part of the frame and to the agricultural tool by means of a ball joint connection for example.

Addressing now the hitching arms and according to a first configuration, the pivot connection 303, 313 of the hitching arms 30, 31 is positioned at their end that is distal relative to the frame, said distal end further forming a fixing for said arms to the agricultural vehicle.

Another subject matter of the invention is a method for operating the hitching device for the tool T mounted on the agricultural vehicle E traveling in the direction (x). According to the invention, when one of the actuating means 302, 312 of the hitching arms 30, 31 commands the offsetting of the hitching device, thus causing the first frame to pivot relative to the transverse direction (y) through an angle a, the means 4 interposed between the proximal first ends of the catching hooks 20, 21 and the first frame 1 are actuated to cause the direction (y′) defined by the connection of the distal second ends 201, 211 to pivot through an angle-a about the vertical axis z so that said direction coincides with the transverse direction (y).

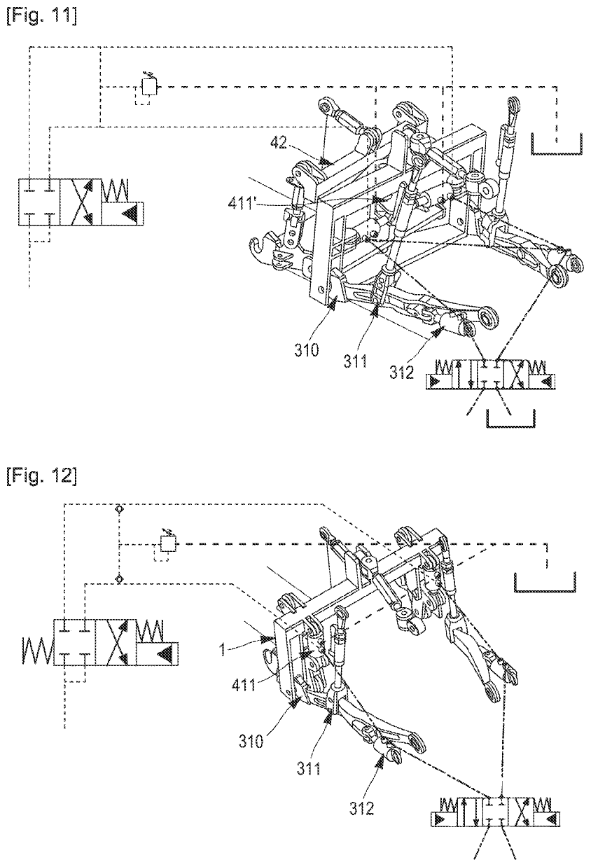

In the case of hydraulic actuation according to a first method of operation and as depicted in FIGS. 11 and 12, the rams 302, 312 are advantageously used to command the offsetting of the hitching arms 30, 31 respectively, and to manage the rams 401, 411 and 401′, 411′, respectively, that control the pivoting means 4.

As depicted in FIGS. 12 and 11 respectively, the ram 302 is then in fluidic communication with the ram 401 or 401′ respectively, and the ram 312 is then in fluidic communication with the ram 411 or 411′, respectively.

In detail, when the ram 312 lengthens, under the effect of the offset command required for positioning the tool on the desired path, the arms of the tractor are offset to the opposite side to the ram 312. The ram 401, 401′ then needs to be lengthened and the ram 411, 411′ shortened so that the orientation of the tool is not modified by the movement in an arc of a circle of the hitching arms of the agricultural vehicle. The drawing force generated by the hitched tool causes the associated ram(s) to lengthen naturally.

The rod side of the ram 312 therefore needs to be connected to the rod side of the ram 411 and the rod side of the ram 302 needs to be connected to the rod side of the ram 401.

In the case of the rams 401′ and 411′ the connections are reversed with the assembly as depicted. If the rams 401′ and 411′ are connected to the frame 2 on the other side of the pivot point the connections may be as per 401, 411.

In detail, the cylinder end wall of the ram 312 connected to the port of one of the outlets of the directional control valve and the cylinder end wall of the ram 302 is connected to the port of the other outlet of the operating directional control valve. The rod of the ram 312 is connected to the rod of the ram 411 (or 411′ respectively) and the rod of the ram 302 is connected to the rod of the ram 401 (or 401′ respectively).

In this way, when the ram 312 lengthens, the oil on the rod side is expelled into the rod side of the ram 410 to force the arm 31 to move forward.

In this movement, the ram 302 shortens. The volume in the rod-side chamber increases and allows the rod-side of the ram 401 to empty, thus allowing the arm 30 to move rearward under the effect of the draft force exerted by the tool.

In the case of the setup with the second frame 42 (and therefore with the rams 401′, 411′), the connection of the rod side 302 is to the rod side 411′ or the cylinder end wall side 401′. The same principle applies symmetrically to the ram 312.

If the rams 401′ and 411′ are connected to the frame 42 to the rear of the pivot point rather than in front, the connections described above are reversed.

The principle is indeed that of orienting the frame 42 in such a way that y′ remains perpendicular or almost perpendicular to the direction of forward travel.

This mode of connection makes it possible to have both rams 401 and 411 the same size.

The connection between the rod-side ports of the rams commanding the offsetting movement 302-312 are therefore in a closed loop with the rod sides of the rams controlling the forward/backward movements 401-411 (or cylinder end wall side with frame 42 and rams 401′ and 411′ connected to the pivot via the opposite side to the tool).

This results in a methodology for synchronizing or, in the event of a leak, for resynchronizing, the rams 302, 312 and the rams 401, 411 or 401′, 411′, respectively.

It is necessary to ensure that the ram chambers are entirely full in order to achieve normal operation.

For this operation, the links commanding the forward/backward movement of arms of the interface are locked in a central position by means of a pin that passes through the upright of the fixed frame and the connecting rod.

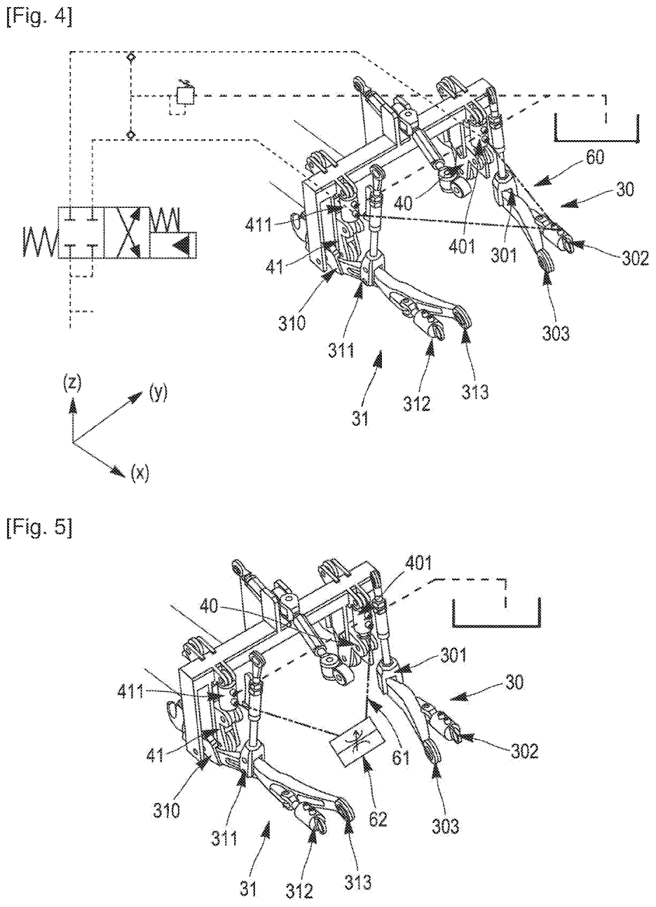

In the case of hydraulic actuation according to a second method of operation and as depicted in FIGS. 4 and 9, the ram 312 is advantageously used to command the offsetting of the hitching arms 30, 31 while the ram 302 is advantageously used to manage the rams 401, 411, or 401′, 411′, respectively that control the pivoting means 4.

The ram 302 is then in fluidic communication with the rams 401, 411 or, respectively, 401′, 411′, in a loop 60 as depicted in FIGS. 4 and 9 respectively.

In detail, when the ram 312 lengthens, under the effect of the desired offset command for positioning the tool on the desired path, the arms of the tractor are offset to the opposite side to the ram 312. The ram 401, 401′ therefore needs to be lengthened and the ram 411, 411′ shortened so that the orientation of the tool is unmodified by the movement in an arc of a circle of the hitching arms of the agricultural vehicle. Under the traction force generated by the hitched tool the associated ram(s) lengthen naturally.

The cylinder end wall side of the ram 302 therefore needs to be connected to the rod side of the ram 411, 411′. The oil expelled from the cylinder end wall side of the ram 302 thus forces the ram 411, 411′ to retract.

In order to ensure operation without alteration of the length of the upper connecting point, it is preferable to use the two rams 401, 401′ and 411, 411′. In addition, that eliminates any pressure imbalance in the rams 302, 312, which could result in uneven operation during right-left and left-right movements.

In order to obtain even operation, the rod side sections of the rams 401 or respectively 401′, and 411 or respectively 411′ need to be adjusted as follows.

The cylinder end wall side of the ram 302 is then connected to the rod side of the ram 411 or respectively 411′. The oil expelled from the ram 302 is supplied to the rod side of the ram 411 or respectively 411′ and forces the catching hook 41 to move towards the rear.

Likewise, the rod side of the ram 302 is connected to the rod side of the ram 401, 401′.

The traction force of the tool pulls the arms and the ram 411 or respectively 411′ empties on the rod side of the ram 302 thus allowing the corresponding arm to move toward the rear.

The connection between the rod-side and cylinder end wall-side ports of the ram 302 is therefore in a closed loop with the rod sides of the rams 401 or respectively 401′ and 411 or respectively 411′.

This results in a methodology to synchronize or, in the event of a leak, resynchronize, the ram 302 (or the rams 302, 312) and the rams 401, 411 or respectively 401′, 411′, as depicted in FIGS. 4 and 9 respectively.

It is necessary to ensure that the ram chambers are entirely full in order to achieve normal operation.

For this operation, the double connecting rods are locked in a central position by means of a pin passing through the upright of the first frame and the double connecting rod.

This locking function is also beneficial when the tool is of the drawn type, which is to say equipped with a physical articulation which eliminates the need to orient that part of the interface that is connected to the tool.

When the directional control valve is an actively controlled valve, the rod sides of the rams 401, 411, or respectively 401′, 411′, and the two chambers of the ram 302 are connected.

By cycling through the movements starting from the ram 312 this ensures that the relevant rams are resynchronized.

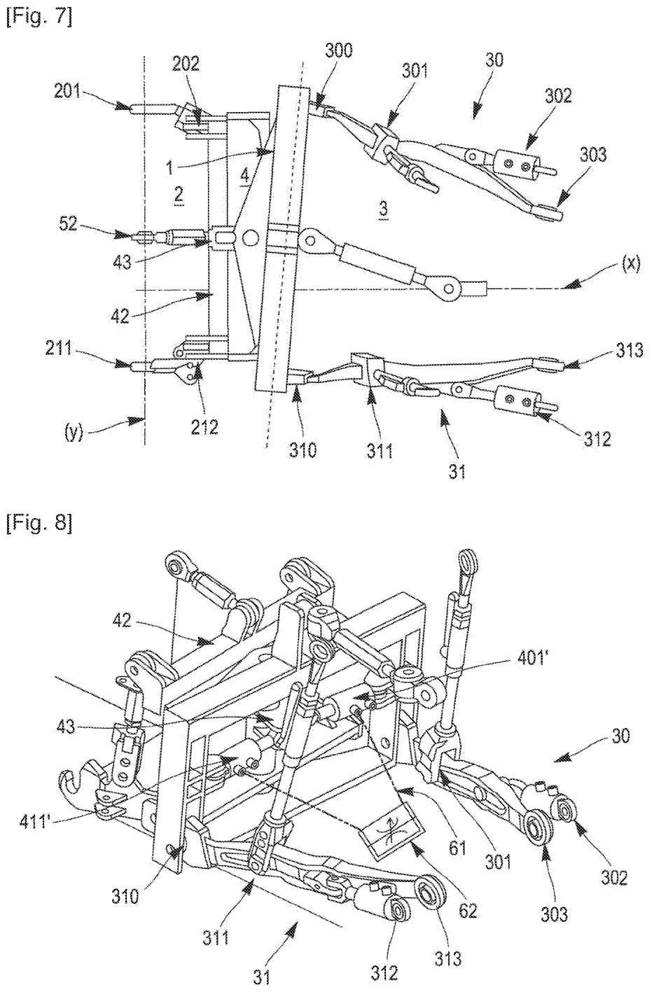

According to an advantageous refinement in the context of hydraulic actuation and as depicted in FIGS. 5 and 8, the rams 401, 411 (or respectively 401′, 411′) are in fluidic communication in a loop 61 that includes a damper 62.

According to this refinement and in instances in which the pivot means comprise double connecting rods, the vertical pivot axis is situated virtually at the middle of the axis that passes through the pivot points of the double connecting rods.

This keeps the lower part of the fixing device 3 clear and avoids potential interference with operating commands for a driven tool.

The damper 62 is a two-way restrictor on the line connecting the rams 401, 411 and prevents the oscillatory movements normally encountered with a hitch short convergence configuration while at the same time allowing alignment relative to the natural line of draft of the tool.

According to this refinement and in instances in which the pivot means comprise a second frame pivoting about the pin 43, the two-way restrictor is on the line connecting the rams 401′, 411′, and prevents the oscillatory movements normally encountered with a hitch short convergence configuration while at the same time allowing alignment relative to the natural line of draft of the tool.

The connection can also be made with the two sides of a double-acting ram with a through-rod, so that the exchange of oil between chambers can occur without blockage. In that case, the ram is affixed using journals.

Thanks to the two-way restrictor, when there is an offset command, the correction occurs gradually. The controlled flow rate between the rams 401, 411 or respectively 401′, 411′ allows natural alignment of the tool while at the same time avoiding the dynamic instability associated with short convergence dynamics.

The free pivoting of the catching hooks 20, 21 avoids parasitic stresses during the movements commanding the sideways offsetting of the tool as it deviates from the required path. The tool maintains the behavior as recommended in the standard ISO 730.

Of course, the invention is not restricted to the examples which have just been described, and numerous modifications may be made to these examples without departing from the scope of the invention. In addition, the various features, shapes, embodiments and implementations of the invention may be combined with one another in various combinations provided that they are not mutually incompatible or mutually exclusive.

1-13. (canceled)

14. A hitching device for hitching a tool, able to be mounted on an agricultural vehicle, comprising:
a first frame extending in a transverse direction substantially perpendicular to the direction of travel of the hitch, said directions defining a horizontal plane,
a fixing device for fixing the first frame to the agricultural vehicle, the fixing device comprising at least two hitching arms extending in a direction close to the direction of travel of the hitch, as well as advantageously a retaining arm, these arms being intended to connect the first frame to the agricultural vehicle, said fixing device being further provided with actuating means,
each of the arms comprising, at its end that is proximal relative to the first frame, a first pivot connection with the first frame, allowing said arm to pivot relative to the first frame about the vertical axis, as well as a second pivot connection with the agricultural vehicle at its end that is distal relative to the first frame, allowing said arm to pivot relative to the agricultural vehicle about the vertical axis, the four pivot connections together thus defining a quadrilateral that can be deformed under the action of the actuating means
wherein the hitching device further comprises a system for coupling the agricultural tool to the first frame, said coupling system comprising two catching hooks extending substantially in the direction of travel of the hitch, each of said catching hooks being provided with a first end referred to as proximal relative to the first frame, designed to pivot freely relative to said frame about the vertical axis, and with a second end, said to be distal relative to the first frame, free and intended to be connected to the tool, said free second ends, once connected to the tool, defining a direction, said coupling system further comprising means interposed between said proximal first ends of the catching hooks and the first frame so as to cause the direction defined by the distal second ends to pivot about the vertical axis.

15. The hitching device as claimed in claim 14, wherein the pivoting means interposed between said proximal first ends of the catching hooks and the first frame are means for actuating the translational movement of the catching hooks independently of one another, in the direction of travel of the hitch.

16. The hitching device as claimed in claim 15 wherein the means for actuating the translational movement of the catching hooks independently of one another in the direction of travel of the hitch consist mainly of a first and a second double connecting rod each respectively articulating one of the first ends of the catching hooks.

17. The hitching device as claimed in claim 16, wherein the actuating means of the fixing device are hydraulic rams and the first and second double connecting rods are actuated in translation respectively by a first and a second hydraulic ram.

18. The hitching device as claimed in claim 14, wherein the pivoting means interposed between said proximal first ends of the catching hooks and the first frame consist mainly of a second frame mounted with the ability to pivot relative to the first frame on a vertical pin, the first ends of the catching hooks then being fixed to the second frame.

19. The hitching device as claimed in claim 18, wherein the actuating means of the fixing device are hydraulic rams and the means for actuating the pivoting of the second frame are a pin made to rotate in opposite directions by a first and a second hydraulic ram.

20. The hitching device as claimed in claim 15, wherein the first ends of the catching hooks are connected to the first frame with a pivot connection pivoting about the direction substantially perpendicular to the direction of travel of the hitch, and retained vertically by link rods mounted on the first frame.

21. The hitching device as claimed in claim 18, wherein the first ends of the catching hooks are connected to the second frame with a pivot connection pivoting about the direction substantially perpendicular to the direction of travel of the hitch, and retained vertically by link rods mounted on the second frame.

22. The hitching device as claimed in claim 14, wherein the hitching device comprises lifting means comprising link rods connected at one of their ends respectively to the hitching arms, which combine with the retaining arms connecting the upper part of the first frame to the agricultural vehicle.

23. A method for operating a hitching device for a tool mounted on an agricultural vehicle traveling in the direction, the device being as claimed in claim 14, wherein when one of the actuating means of the hitching arms commands the offsetting of the hitching device, thus causing the first frame to pivot relative to the transverse direction through an angle a, the means interposed between the proximal first ends of the catching hooks and the first frame are actuated to allow the direction defined by the connection of the distal second ends to the tool to pivot through an angle a about the vertical axis so that said direction coincides with the transverse direction.

24. The method for operating a hitching device for a tool mounted on an agricultural vehicle traveling in the direction as claimed in claim 23, wherein the actuating means are rams each respectively used to command the offsetting of the hitching arms and to manage the rams that control the pivoting means, the ram being in fluidic communication with the ram and the ram being in fluidic communication with the ram.

25. The method for operating a hitching device for a tool mounted on an agricultural vehicle traveling in the direction as claimed in claim 23, wherein one of the actuating means is a ram used to command the offsetting of the hitching arms, while the other actuating means is a ram used to manage the rams which control the pivoting means, the ram being in fluidic communication with the ramsin a loop.

26. The method for operating a hitching device for a tool mounted on an agricultural vehicle traveling in the directions claimed in claim 23, wherein the rams are in fluidic communication in a loop which includes a damper.
